(19) United States
(12) Patent Application Publication
(10) Pub. No.: US 2011/0262152 A1
(43) Pub. Date: Oct. 27, 2011

(54) METHOD AND APPARATUS OF SHEET CONVEYANCE (SHEET CONVEYANCE CONTROL WITH MEDIA SENSOR) AND IMAGE FORMING APPARATUS

(75) Inventor: Susumu Koizumi, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/089,745

(22) Filed: Apr. 19, 2011

Related U.S. Application Data
(60) Provisional application No. 61/326,550, filed on Apr. 21, 2010.

(51) Int. Cl. G03G 15/00; B65H 7/02

(52) U.S. Cl. 399/16; 271/265.04; 271/258.03; 399/389

(57) ABSTRACT

According to one embodiment, a sheet conveying mechanism including a first driving mechanism configured to move a sheet medium to a predetermined position, a second driving mechanism located a fixed distance apart from the first driving mechanism and configured to move the sheet medium to the first driving mechanism, a thickness detecting mechanism located between the first driving mechanism and the second driving mechanism and configured to determine thickness of the sheet medium moving between the driving mechanisms, and a controller configured to change, on the basis of the thickness of the sheet medium detected by the thickness detecting mechanism, start of the first driving mechanism and change a movement amount per unit time of the second driving mechanism.

### CROSS-REFERENCE TO RELATED APPLICATIONS

This application is based upon and claims the benefit of priority from: U.S. Provisional Application No. 61/326,550 filed on Apr. 21, 2010, the entire contents of each of which are incorporated herein reference.

### FIELD

Embodiments described herein relate generally to a sheet conveyance control with media sensor and an image forming apparatus using the control.

### BACKGROUND

A toner (a visualizing agent) moves to a sheet medium on the basis of image information and is integrated with the sheet medium. The sheet medium (integrated with the toner) is a hard copy.

In a case when, the thickness of the sheet medium is thick, a conveyance of the sheet medium is changed and occurs a color drift/an error of align of colors or an error of align of leading edge of image on the sheet medium.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of an MFP, according to an embodiment;

FIG. 2 is an exemplary diagram showing an example of an MFP, according to an embodiment;

FIG. 3 is an exemplary diagram showing an example of an MFP, according to an embodiment;

FIG. 4 is an exemplary diagram showing an example of an MFP, according to an embodiment;

FIG. 5 is an exemplary diagram showing an example of an MFP, according to an embodiment;

FIG. 6 is an exemplary diagram showing an example of the MFP according to an embodiment; and

FIG. 7 is an exemplary diagram showing an example of the MFP according to an embodiment.

### DETAILED DESCRIPTION

In general, according to one embodiment, a sheet conveying mechanism comprising: a first driving mechanism configured to move a sheet medium to a predetermined position; a second driving mechanism located a fixed distance apart from the first driving mechanism and configured to move the sheet medium to the first driving mechanism; a thickness detecting mechanism located between the first driving mechanism and the second driving mechanism and configured to determine thickness of the sheet medium moving between the driving mechanisms; and a controller configured to change, on the basis of the thickness of the sheet medium detected by the thickness detecting mechanism, start of the first driving mechanism and change a movement amount per unit time of the second driving mechanism.

Embodiments will now be described hereinafter in detail with reference to the accompanying drawings.

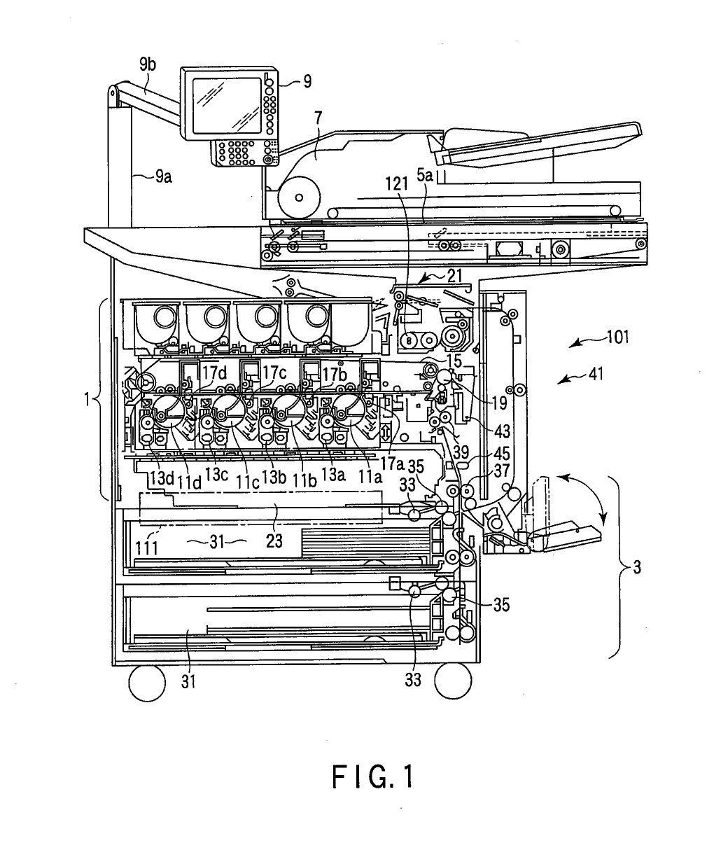

FIG. 1 schematically shows an MFP (Multi-Functional Peripheral) to which the embodiment is able to apply.

An MFP 101 shown in FIG. 1 has an image forming section (a printer section) 1 for outputting image information as an output image which is referred to as a hard copy or a print out, a sheet feeder 3 to supply a sheet medium having an optional size, which is used for an image output, to the image forming section 1, and a scanner section 5 to provide image data of an original to the image forming section 1.

Moreover, the scanner section 5 integrally has an automatically-document feeder (ADF) 7 the original to a reading position on the scanner section 5.

A control panel 9 for giving an instruction for starting image formation in the image forming section 1 and starting to read image information of the original through the scanner section 5 is placed in a strut 9a fixed to the image forming section 1 and a swing arm 9b in a corner at a left or right side behind the scanner section 5.

The image forming section 1 includes first to fourth photoconductive drums 11a to 11d for holding latent images, developers 13a to 13d for supplying a toner to the latent images on the photoconductive drums 11a to lid to develop toner images, a transfer belt 15 for holding the toner images transferred from the photoconductive drums 11a to 11d in order, cleaners 17a to 17d for cleaning the individual photoconductive drums 11a to lid, a transfer roller 19 for transferring the toner image held by the transfer belt 15 onto a sheet medium, a fuser 21 for fixing the toner image transferred to the sheet medium by the transfer roller 19 onto the sheet medium, and an exposing device 23 for forming latent images on the photoconductive drums 11a to 11d.

The first to fourth developers 13a to 13d store toners having optional colors of Y (yellow), M (magenta), C (cyan) and Bk (black) which are used for obtaining a color image by a subtractive process and visualize a latent image held by each of the photoconductive drums 11a to lid in any of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to lid and the corresponding developers 13a to 13d in order (of the formation of the toner images).

The sheet feeder 3 supplies the sheet medium to be transferred the toner image by the transfer roller 19.

Cassettes positioned in a plurality of cassette slots 31 store sheet media having optional sizes. Depending on an image forming operation, a pickup roller 33 takes the sheet medium out of the corresponding cassette. The size of the sheet medium corresponds to a size of the toner image formed by the image forming section 1.

A separating mechanism 35 prevents at least two sheet media from being taken out of the cassette by the pickup roller 33.

A plurality of delivery rollers 37 feed the sheet medium separated to be one sheet medium by the separating mechanism 35 toward a registration (an aligning) roller 39.

The registration roller 39 feeds the sheet medium to a transfer position in which the transfer roller 19 and the transfer belt 15 come in contact with each other in a timing to transfer the toner image from the transfer belt 15 by the transfer roller 19.

The transfer roller 19 is positioned in an automatically-duplex unit (ADU) 41 for replacing both sides of the sheet medium, that is, the output image (hard copy, print out) which has the toner image fixed thereto by the fuser 21.

The fuser 21 fixes the toner image corresponding to the image information onto the sheet medium as the output image (hard copy, print out) and feeds the output image to a stocker 101a positioned in a space between the scanner section 5 and the image forming section 1.

The ADU 41 moves to a side (a right side) with respect to the image forming section 1, if the sheet medium is jammed between the delivery roller 37 (a final one) and the registration roller 39 or between the registration roller 39 and the fuser 21, that is, in the transfer roller 19 or the fuser 21. The ADU 41 integrally has a cleaner 25 to clean the transfer roller 19.

A media sensor 45 to detect thickness of the sheet medium conveyed to the registration roller 39 in the path between the delivery roller (final one) 37 and the registration roller 39. The media sensor 45 useable benefit of priority from: U.S. patent applications No. 12/197,880 filed on Aug. 25, 2008 and No. 12/199,424 filed on Aug. 27, 2008 and/or a shift of thickness detecting roller type benefit of priority from: U.S. Provisional Application No. 61/043,801 filed on Apr. 10, 2008, each of which are incorporated.

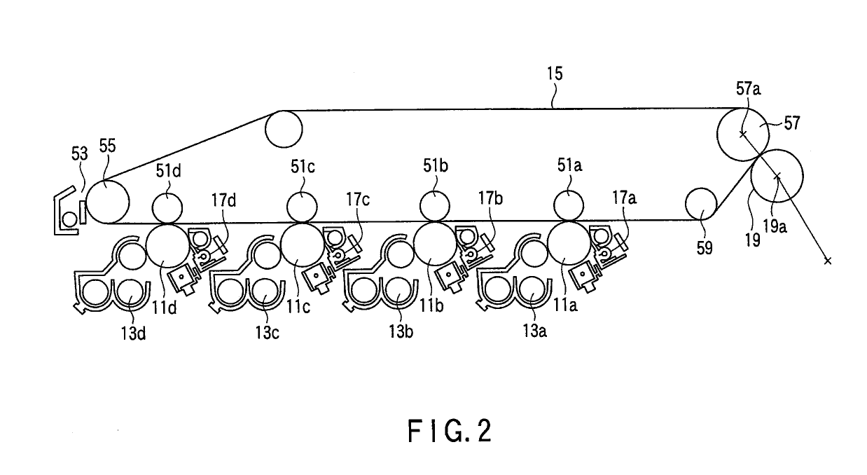

FIG. 2 shows a transfer section of an imaging section in the MFP shown in FIG. 1.

A bend of a belt surface of the transfer belt 15 is a fixed amount related to tension from at least one tension device. The belt opposed member 51, the belt cleaner opposed member 55, and the transfer opposed member 57 are, for example, roller members. The belt opposed member 51 provides the transfer belt 15 (and the photoconductive drums 11a to lid) with a transfer voltage (an electrostatic field). The transfer roller 19 applies, when the sheet material moves between the transfer roller 19 and the transfer belt 15, pressure for transfer to the sheet material (and the transfer belt 15). The transfer roller 19 provides the sheet material (and the transfer belt 15) with a transfer voltage (an electrostatic field).

As shown in FIGS. 1 and 2, the media sensor 45 is located between the registration roller 39 and the delivery rollers 37 (the final one) (on a paper feeding upstream side of the registration roller 39).

Timing when the registration roller 39 starts, the rotating speed of the registration roller 39, the rotating speed of the transfer roller 19, the moving speed of the transfer belt 15, and rotating speed of a roller included in the fuser 21 are set on the basis of the thickness (the basis weight) of the sheet medium detected by the media sensor 45. When necessary, the rotating speed of the delivery rollers 37 may be set.

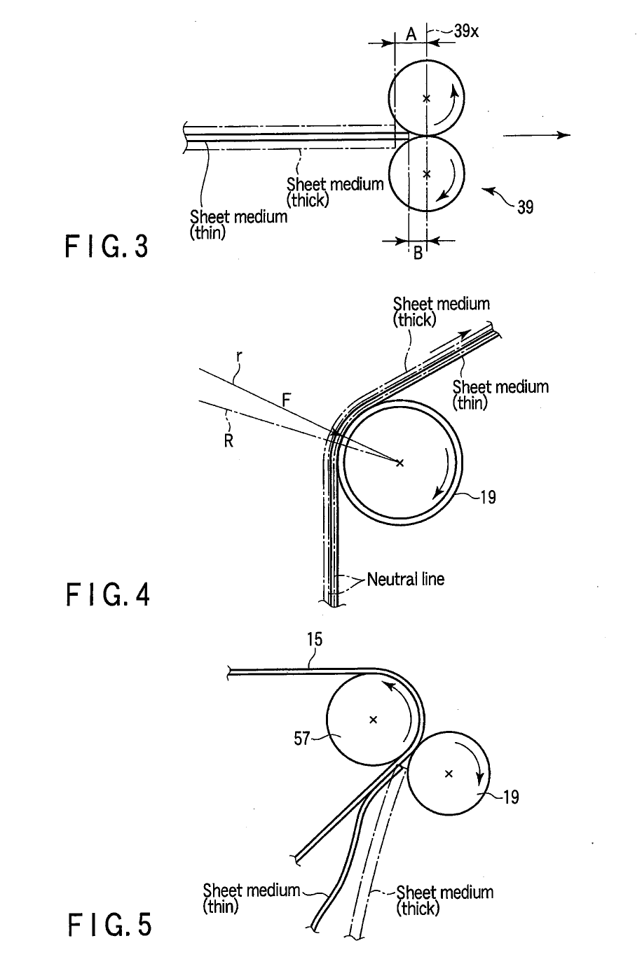

More specifically, as shown in FIG. 3, because of the influence of the thickness of the sheet medium, in the registration roller 39, a distance A between a line segment 39X connecting the centers of two rollers of the sheet medium temporarily stopped and the leading end of the sheet medium (thick) is larger than a distance B between the line segment 39X connecting the centers of the two rollers of the sheet medium and the leading end of the sheet medium (normal/thin). Therefore, if a detection result of the media sensor 45 is, for example, the sheet medium (thick), it is desirable to set starting timing of the registration roller 39 early compared with starting timing of the registration roller 39 for the sheet medium (normal).

As shown in FIG. 4, a neutral line (a distance from a median of the thickness to the surface) R of the sheet medium (thick) is large compared with a neutral line r of the sheet medium (normal/thin).

Specifically, when the sheet medium moves on the outer circumference (the curved surface) of each of the rollers, since the sheet medium twines around the roller, it can be considered that the outer diameter (D/2) of the roller changes (increases) to a neutral line (r)/(R) of the sheet medium. This means that, if R represents a distance from the center of the roller to the neutral line of the sheet medium (thick) and r represents a distance from the center of the roller to the neutral line of the sheet medium (thin),

R>r>D/2.

Therefore, the speed of movement of the sheet medium (thick) along the outer circumference of the roller is high compared with the speed of the sheet medium (normal/thin). Consequently, if a detection result of the media sensor 45 is, for example, the sheet medium (thick), it is desirable to reduce (lower) the rotating speed of the delivery rollers 37, the rotating speed of the transfer roller 19, the moving speed of the transfer belt 15, and the rotating speed of the roller included in the fuser 21 compared with those in the case of the sheet medium (normal).

As shown in FIG. 5, since the sheet medium (thick) is chewy/firm, a distance of movement between the registration roller 39 and the deliver rollers 37 (the final one) is often small compared with a moving distance of the sheet medium (normal/thin). In other words, a moving path of the sheet medium (normal/thin) is often closer to the transfer belt 15. Therefore, concerning the sheet medium (thick), it is desirable to reduce (lower) the rotating speed of the delivery rollers 37, the rotating speed of the transfer roller 19, and the moving speed of the transfer belt 15 compared with those in the case of the sheet medium (normal).

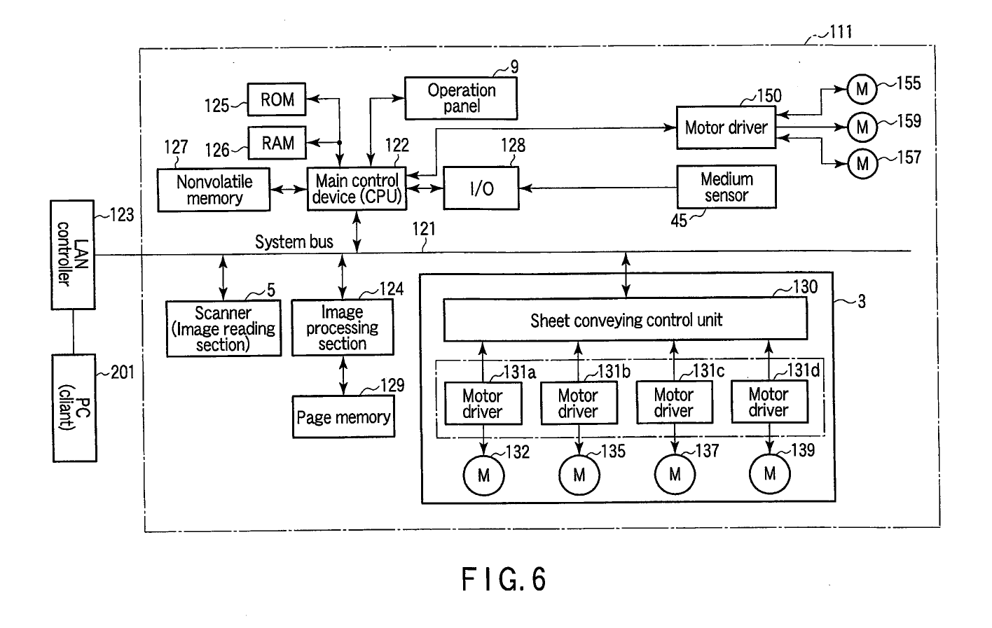

As indicated by an example shown in FIG. 6, a control unit 111 includes a system bus 121.

The system bus 121 is connected to a main control block configured to process an output of a copy of an original document by the image forming section 1, i.e., a main control block (a CPU) 122. The CPU (the main control block) 122 is connected to the scanner (image reading) section 5, the ADF (auto document feeder) 7, and an operation unit 9. The control unit 111 also includes an image processing section 124 connected to the CPU 122 via the system bus 121 and configured to apply image processing which is requested by the image forming section 1 to form an output image, to image data input from the scanner section 5, a client (PC (Personal Computer)) 201 connected through a LAN (Local Area Network) controller 123, or the like.

The CPU 122 is also connected to a ROM (Read Only Memory) 125, a RAM (Random Access Memory) 126, and a nonvolatile memory 127 configured to store a total number of times of image formation, a total operation time, and the like.

The CPU 122 acquires, from an output of the media sensor 45 connected to an I/O (input output port/interface) 128, the thickness of the sheet medium moving from an arbitrary cassette 31 in the sheet feeder 3. The CPU 122 sets, according to the output of the media sensor 45, in a motor driver 150 connected to the I/O (input output port/interface) 128, the number of revolutions of a roller 55 rotated by a motor 155 and sets the moving speed of the transfer belt 15. For example, the photoconductive drums 11a to lid receive the rotation of the motor 155 through a gear train and rotate at predetermined speed. The CPU 122 sets, in the motor driver 150, the number of revolutions of the roller in the fuser 21 rotated by a motor 157 (the moving speed of the roller surface) and the number of revolutions of the transfer roller 19 rotated by the motor 157 (the moving speed of the roller surface) to predetermined speed

The motor drivers 131a, 131b, 131c, and 131d may be integrated.

The image forming section 124 generates output data corresponding to an output image (output image data) on a map of a page memory 129 connected to the image processing section 124.

According to exposure data, i.e., Y (yellow), M (magenta), C (cyan), and Bk (black) prepared to correspond to the output image on the map of the page memory 129, the exposing device 23 forms latent images on the respective photoconductive drums 11a to 11d.

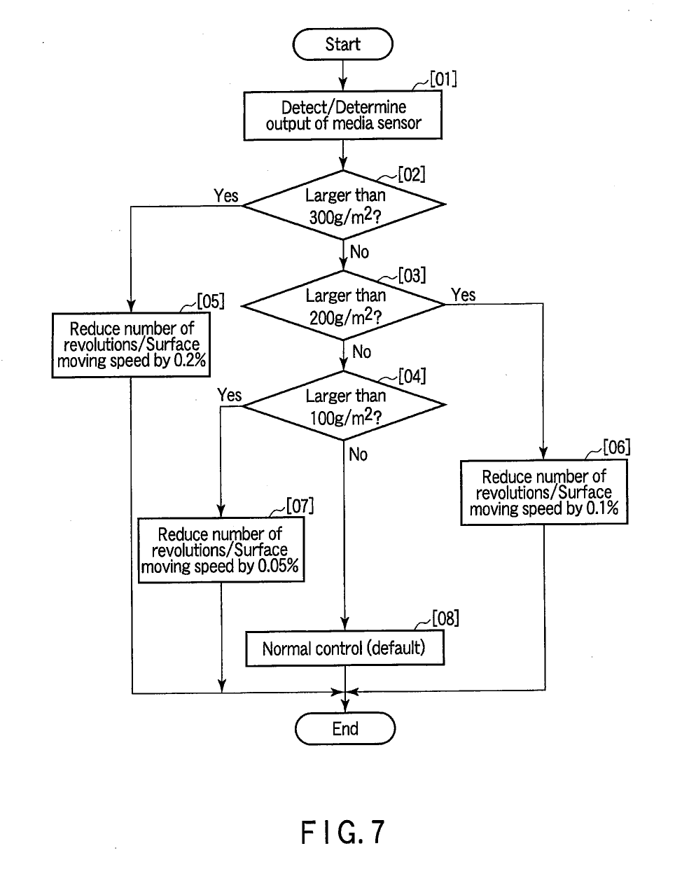

FIG. 7 shows, in terms of software, an example in which timing for starting the registration roller 39, the rotating speed of the registration roller 39, (the rotating speed of the delivery rollers 37), the rotating speed of the transfer roller 19, the moving speed of the transfer belt 15, and the rotating speed of the roller included in the fuser 21 are set on the basis of the thickness of the sheet medium detected by the media sensor 45 shown in FIGS. 3 to 5.

First, the thickness of the sheet medium detected by the media sensor 45 is acquired [01].

If the acquired thickness (basis weight) of the sheet medium is larger than 300 g/m² [02-YES], the rotating speed of the registration roller 39, the rotating speed of the transfer roller 19, the moving speed of the transfer belt 15, and the rotating speed of the roller included in the fuser 21 are reduced by 0.2% [05].

If the acquired thickness (basis weight) of the sheet medium is larger than 200 g/m² [02-NO] through [03-YES], the rotating speed of the registration roller 39, the rotating speed of the transfer roller 19, the moving speed of the transfer belt 15, and the rotating speed of the roller included in the fuser 21 are reduced by 0.1% [06].

If the acquired thickness (basis weight) of the sheet medium is larger than 100 g/m² [03-NO] through [04-YES], the rotating speed of the registration roller 39, the rotating speed of the transfer roller 19, the moving speed of the transfer belt 15, and the rotating speed of the roller included in the fuser 21 are reduced by 0.05% [07].

If the acquired thickness (basis weight) of the sheet medium is equal to or smaller than 100 g/m² [04-NO], normal control is performed [08].

In this way, at least one of the timing for starting the registration roller, the rotating speed of the registration roller, the rotating speed of the transfer roller, the moving speed of the transfer belt, the rotating speed of the roller included in the fuser, and the rotating speed of the delivery rollers is optimized on the basis of the thickness of the sheet medium detected by the media sensor. This makes it possible to suppress a color shift or a shift of the position of an image at the leading end that could be caused by the influence of the thickness of the sheet medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sheet conveying mechanism comprising:
a first driving mechanism configured to move a sheet medium to a predetermined position;
a second driving mechanism located a fixed distance apart from the first driving mechanism and configured to move the sheet medium to the first driving mechanism;
a thickness detecting mechanism located between the first driving mechanism and the second driving mechanism and configured to determine thickness of the sheet medium moving between the driving mechanisms; and;
a controller configured to change, on the basis of the thickness of the sheet medium detected by the thickness detecting mechanism, start of the first driving mechanism and change a movement amount per unit time of the second driving mechanism.

2. The mechanism of claim 1, wherein the first driving mechanism temporarily stops the movement of the sheet medium moved by the second driving mechanism and starts the movement of the sheet medium at predetermined timing by the controller.

3. The device of claim 2, wherein the first driving mechanism brings forward, if the thickness of the sheet medium is larger than a predetermined value, timing for starting the movement of the sheet medium compared with timing for starting the movement of the sheet medium having the thickness equal to or smaller than the predetermined value.

4. The mechanism of claim 1, wherein the second driving mechanism suppresses, if the thickness of the sheet medium is larger than a predetermined value, the movement amount per unit time of the sheet medium moving to the first driving mechanism compared with a movement amount per unit time of the sheet medium having the thickness equal to or smaller than the predetermined value.

5. The mechanism of claim 4, wherein the controller sets the movement amount per unit time of the sheet medium moving to the first driving mechanism to one of two or more different movement amounts.

6. A sheet conveying method comprising:
temporarily stopping movement of a moving sheet medium at a temporary stop position; and
changing, when moving the temporarily-stopped sheet medium again, timing for movement start when moving the sheet medium again and changing a movement amount per unit time of the sheet medium moving to the temporary stop position on the basis of detected thickness of the sheet medium.

7. The method of claim 6, wherein, if the thickness of the sheet medium is larger than a predetermined value, timing for starting the movement of the sheet medium is brought forward compared with timing for starting the movement of the sheet medium having the thickness equal to or smaller than the predetermined value.

8. The method of claim 6, wherein, if the thickness of the sheet medium is larger than a predetermined value, the movement amount per unit time of the sheet medium moving to the temporary stop position is suppressed compared with a movement amount per unit time of the sheet medium having the thickness equal to or smaller than the predetermined value.

9. The method of claim 8, wherein the movement amount per unit time of the sheet medium moving to the temporary stop position is set to one of two or more different movement amounts related to the thickness of the sheet medium.

10. An image forming apparatus comprising:
a transfer device configured to transfer an image formed of visualizing agents onto a sheet medium;
an image carrying mechanism configured to move the image formed of the visualizing agents such that the transfer device can transfer the image onto the sheet medium;
a first driving mechanism configured to guide the sheet medium to the transfer device and temporarily stop the movement of the sheet medium in order to set a position of the image moved by the image carrying mechanism on the sheet medium;
a second driving mechanism configured to move the sheet medium to the first driving mechanism;
a thickness detecting mechanism located between the first driving mechanism and the second driving mechanism and configured to determine thickness of the sheet medium moving between the driving mechanisms; and
a controller configured to change, on the basis of the thickness of the sheet medium detected by the thickness detecting mechanism, start of the first driving mechanism, change a movement amount per unit time of the second driving mechanism, and change a movement amount per unit time of the sheet medium moving when the transfer device transfers the image from the image carrying mechanism onto the sheet medium.

11. The apparatus of claim 10, wherein the first driving mechanism temporarily stops the movement of the sheet medium moved by the second driving mechanism and starts the movement of the sheet medium at predetermined timing by the controller.

12. The apparatus of claim 11, wherein the first driving mechanism brings forward, if the thickness of the sheet medium is larger than a predetermined value, timing for starting the movement of the sheet medium compared with timing for starting the movement of the sheet medium having the thickness equal to or smaller than the predetermined value.

13. The apparatus of claim 10, wherein the second driving mechanism suppresses, if the thickness of the sheet medium is larger than a predetermined value, the movement amount per unit time of the sheet medium moving to the first driving mechanism compared with a movement amount per unit time of the sheet medium having the thickness equal to or smaller than the predetermined value.

14. The apparatus of claim 13, wherein the movement amount per unit time of the sheet medium moving to the first driving mechanism is set to one of two or more different movement amounts.

15. The apparatus of claim 10, wherein the controller suppresses, if the thickness of the sheet medium is larger than a predetermined value, the movement amount per unit time of the sheet medium moving when the transfer device transfers the image from the image carrying mechanism onto the sheet medium more compared with a movement amount per unit time of the sheet medium having the thickness equal to or smaller than the predetermined value.

16. The apparatus of claim 15, wherein the controller sets, if the thickness of the sheet medium is larger than the predetermined value, the movement amount per unit time of the sheet medium to smaller one of two or more different movement amounts compared with a movement amount set for the sheet medium having the thickness equal to or smaller than the predetermined value.

17. The apparatus of claim 10, further comprising an integrating device including at least a roller member that can apply pressure and heat to the sheet medium and the visualizing agents and configured to integrate the visualizing agents, which is moved from the image carrying mechanism onto the sheet medium by the transfer device, with the sheet medium.

18. The apparatus of claim 17, wherein the controller suppresses, if the thickness of the sheet medium is larger than a predetermined value, a movement amount per unit time of a peripheral surface of the roller member compared with a movement amount per unit time of the sheet medium having the thickness equal to or smaller than the predetermined value.

19. The apparatus of claim 18, wherein the controller sets, if the thickness of the sheet medium is larger than the predetermined value, the movement amount per unit time of the sheet medium to smaller one of two or more different movement amounts compared with a movement amount set for the sheet medium having the thickness equal to or smaller than the predetermined value.

20. The apparatus of claim 17, wherein the visualizing agents can reproduce an arbitrary color through a subtractive process.

21. The apparatus of claim 20, wherein the integrating device realizes color mixing of the visualizing agents based on the subtractive process.

22. The apparatus of claim 21, wherein at least one of the visualizing agents includes an achromatic color.
